(19) United States
(12) Patent Application Publication
(10) Pub. No.: US 2026/0094057 A1
(43) Pub. Date: Apr. 2, 2026

(54) ASYNCHRONOUS, SCALABLE AND CUSTOMIZABLE MODEL SERVING OVER PIPES

(71) Applicant: Freshworks Inc., San Mateo, CA (US)

(72) Inventor: Arrman Anicket SAHA, Mumbai (IN)

(73) Assignee: Freshworks Inc., San Mateo, CA (US)

(21) Appl. No.: 18/903,479

(22) Filed: Oct. 1, 2024

(51) Int. Cl. G06N 20/00

(52) U.S. Cl. CPC G06N 20/00

(57) ABSTRACT

A method for serving machine learning (ML) model over at least two pipes includes defining a function that receives at least two process pipes as arguments, and defining another class. The other class is used for creating and storing future objects and setting the result from another thread. The method also includes releasing a semaphore to avoid overloading of a second pipe once the data is sent to the other thread, and writing an asynchronous function to a first pipe or an input pipe in order to send the data to the other thread.

### FIELD

The present invention relates to machine learning (ML) models, and more particularly, creating and servicing asynchronous, scalable and customizable models over pipes.

### BACKGROUND

Serving large, custom, multistage ML models is non-trivial in software applications such as Python™ because of a global interpreter lock (GIL), which is a locking mechanism ensuring that only one thread executes Python™ code at a time. In short, GIL prevents true multithreading except for specific cases where a different library releases the GIL. This means that if an application that uses an artificial intelligence (AI) model, the non-dependent AI parts of the application may be slowed down when processing is required for running the AI model.

It should also be appreciated that the addition of libraries in the main application may also cause other interactions with threading or event loops, which may affect performance and/or stability. For example, there have been multiple performance reductions related to usage of default multithreaded in flask, and reduced performance in FastAPI under high load with multiple models (due to event loop being blocked), as well as one instance of a memory leak on specific versions of Pytorch™ and Flask™.

When a microservice is built, there are many tasks that need to be performed. These tasks include cleaning up data and libraries, sending data to other places (e.g., database calls), running inference of a larger model, to name a few. Current techniques to integrate a model into a microservice in a way that allows for the microservice to execute efficiently is not present. For example, the existing thread pool executor and the process pool executor do not allow for batching nor do they allow for custom logic to be written where multiple models can be run on different frameworks.

If model serving is used, where tasks are separated from the microservice, there is an increase in the cost of network overhead coupled with the additional of network latency. The latency, although a few milliseconds, can create a traffic congestion on the network. In addition, with model serving, there is a limitation of how much data can be sent back and forth on the network.

To address this challenge, an alternative solution may be beneficial. For example, with the network architecture described in the embodiments below, there can be models from different frameworks running in a single call with batching in a different process with low overhead and no latency.

### SUMMARY

Certain embodiments of the present invention may provide solutions to the problems and needs in the art that have not yet been fully identified, appreciated, or solved by current techniques for serving ML models. For example, some embodiments pertain to a technique that delegates a separate, but custom, process running in the same environment as the application and communicating of the process over pipes. This may lead to isolation of the process while maintaining low latency.

In an embodiment, a computer-implemented method for serving a ML model includes defining a function that receives at least two process pipes as arguments. The method also includes defining another class, where the other class is used for creating and storing future objects and setting the result from another thread. The method further includes releasing a semaphore to avoid overloading of the pipe once the data is sent to the other thread, and writing an asynchronous function to an input pipe in order to send the data to the other thread.

In another embodiment, a system configured to serve a ML model includes at least one processor, and memory comprising a set of instructions. The set of instructions are configured to cause the at least one processor to execute defining a function that receives at least two process pipes as arguments. The set of instructions are further configured to cause the at least one processor to execute defining another class, where the other class is used for creating and storing future objects and setting the result from another thread. The set of instructions are further configured to cause the at least one processor to execute releasing a semaphore to avoid overloading of the pipe once the data is sent to the other thread, and writing an asynchronous function to an input pipe in order to send the data to the other thread.

In yet another embodiment, a computer-implemented method for processing batched data using a plurality of pipelines includes receiving, from a first process, data comprising a plurality of text, each of which corresponding to one of a plurality of models, and batching, at a second process, the data. The method includes sending, at the second process, the batched data to a corresponding one of a plurality of pipelines. The method also includes executing, at the second process, each of the corresponding ones of the plurality of pipelines for the batch data, and returning, from the second process, to the first process a final result from the executed corresponding ones of the plurality of the pipelines.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a diagram illustrating a model serving architecture, according to an embodiment of the present invention.

FIG. 2 is a flow diagram illustrating a method for processing batched data using a plurality of pipelines, according to an embodiment of the present invention.

FIG. 3 is an architectural diagram illustrating a computing system configured to perform ML model serving on a separate thread, according to an embodiment of the present invention.

FIG. 4 is a flow diagram illustrating a method for launching a defined function and communicating the defined function over pipes, according to an embodiment of the present invention.

FIG. 5 is a flow diagram illustrating a computer-implemented method for serving ML model over pipes, according to an embodiment of the present invention

### DETAILED DESCRIPTION OF THE EMBODIMENTS

Some embodiments generally pertain to a technique for running compute limited functions while maintaining compatibility with async, low overheads, while still being completely customizable. In some embodiments, another process is launched that runs a defined function during application startup and communicates with it over pipes in two (2) threads to run the model.

In certain embodiments, a function, which takes two process pipes as arguments are defined. In these embodiments, the function has two parts, i.e., any library imports and model loading, which will use RAM/VRAM, and while True loop where the input(s) is taken from the first pipe, the model(s) loaded in the first part is/are run and output is sent to the second pipe.

It should be noted that the process is started by running the function indefinitely. There may be several advantages to using this process. For example, the function is very lightweight (in terms of memory, compute, imports) to create, import into other modules and is fully initialized and utilizes the required resources in another process. Another advantage includes the ability to customize the while true loop to allow batching, freeze garbage collection of model objects, including other optimizations, as well as place where the model is loaded. Yet another advantage includes the ability for the application to be isolated from the model processing crashing, as well as the overhead being close to but less than the process pool executor.

The issue with this approach is that the overhead is more than threading, and the optimizations need to be done manually rather than automatically happening in the model serving framework. To interact with this process efficiently, another class is defined. This defined class handles the creation and storage of future objects, setting of the result to it from another thread, using semaphore to avoid overloading the pipe, and implementing an asynchronous function that writes to the input pipe and awaits a created future object.

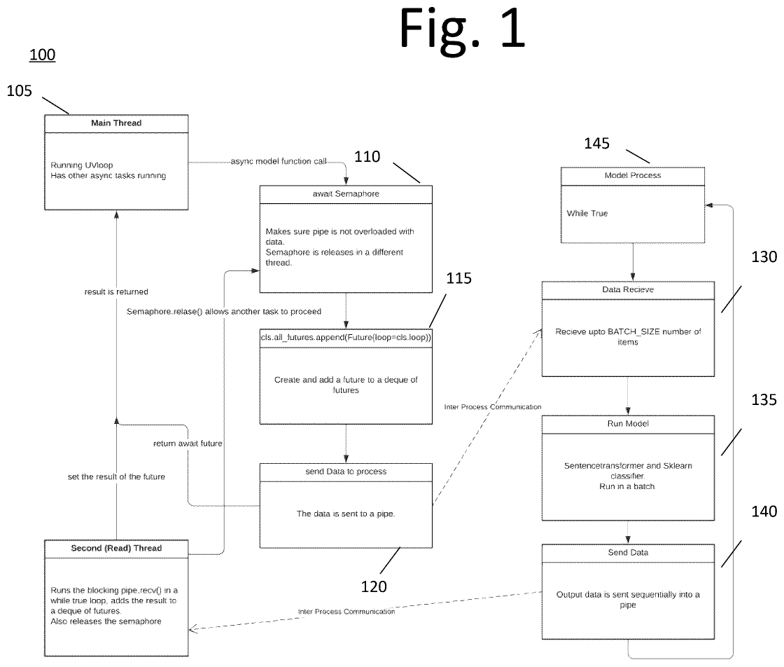

FIG. 1 is a diagram illustrating a model serving architecture 100, according to an embodiment of the present invention. In some embodiments, the main application (or main thread) 105, which is running several tasks (or programs), includes application programming interfaces (APIs), databases, and other smaller processes. Now, prior to running a model, a request function (or a async model function call) is sent through a semaphore 110. Semaphore 110 is a limit, and a future object is created for the semaphore. This embodiment may be Python™ specific. The semaphore, in some embodiments, ensures that the pipe is not overloaded with data.

In some embodiments, a data structure is created and a future is added to a double-ended-queue (deque) of a plurality of futures. See 115. It should be noted that a data structure is a list that holds multiple futures. Futures for purposes of explanation are Python™-specific objects that indicate that a result is not yet set but will be set at a later point in time.

Once the future objected is created, data is sent to different models (i.e., the different processes that are created). See 120. In this embodiment, a pipe.send function called is made to send the data the second process (i.e., the model process). The future that was created earlier is waiting to be set. This future result is set once the second read thread gets data from the model process.

At 130, a data receive function is called. In this embodiment, custom batching and models from multiple frameworks is enabled. For example, data is received at the model process function (i.e., a batch size number of items is received). The model process function may simultaneously receive up a batch size of items before running the model. This feature provides a more efficient process than other prior techniques discussed above.

It should be appreciated that batching is a process where multiple distinct texts (i.e., inputs from different requests) are processed at one time, by executing operations on one large matrix instead of multiple small matrixes. This can, in some cases, be very efficient. Batch size is the number of distinct texts that are processed in one shot.

At 135, the model is run, i.e., a sentence transformer and a SKlearn classifier model is run in a batch. Once the batch of data is accumulated (e.g., ten sentences of text), the model is executed with the batch size. Using the vectors from the batch size, the model output is taken from the sentence transformer model. The model output is then run in a SK Lean classification model to classify the model. The final result of the classification is sent to the second read thread. It should be appreciated that, when processing some inputs, requests may be incoming. For these incoming requests that are in a waiting state, a predefined/predetermined ‘batch size’ amount of items may be selected. These items are inserted as a single batch into the sentence transformer model, and then the items are individually processed through a SKLearn model.

Once the process is complete, the data at 140 is sent to another (or second) thread, and the process returns to the model process at 125. It should be noted that the second thread runs parallel to the main thread. This main thread sets the result of the future and send the set result of the future back to the main thread. See 145.

The semaphore is a limiter. For example, when the semaphore is acquired, the semaphore prevents all data from entering the pipe. The second thread should also increase the limit back up by setting the future, allowing more data to pass through the second thread. The semaphore may also adjust the priority of the request in some embodiments.

In some embodiments, once the second thread sets the result of the future, the result is passed back in the main thread. During this process, the main thread may continue to run its functions without being hindered by the model serving process, because of the two threads running in parallel (and independent) of each other.

In short, there is a first process, which is the main application, and concurrently, there is a second thread running. There is a second process running as a while loop (or continuous loop). See step 145. The second thread receives the output of the second process.

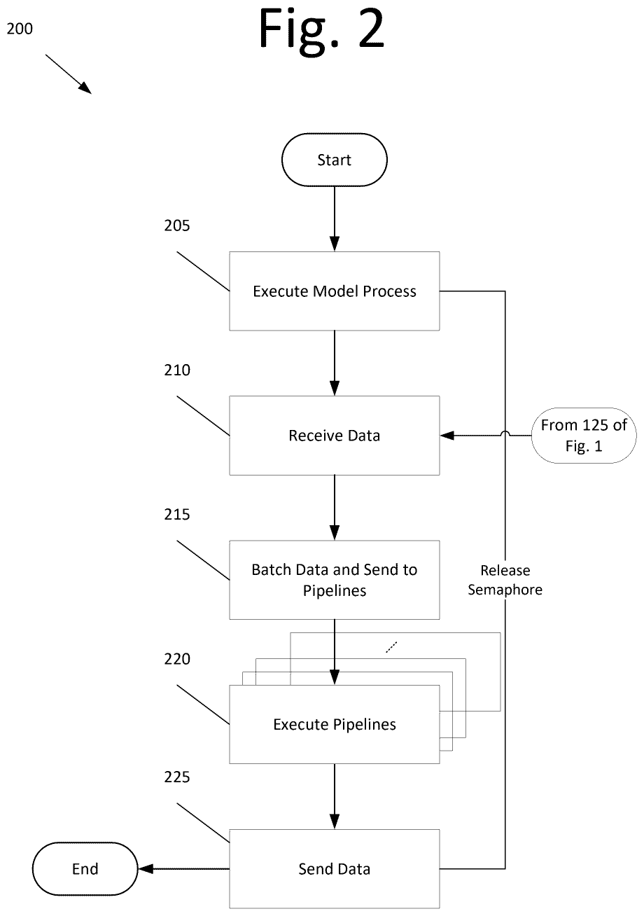

In an alternative embodiment, the second process may execute a plurality of pipelines in order to process the batched data. See, for example, FIG. 2, which is a flow diagram illustrating a method 200 for processing batched data using a plurality of pipelines, according to an embodiment of the present invention. These pipelines, and data send may be run in parallel in a threadpool executor within the model process, with a semaphore and lock to limit concurrency of the pipeline and data send respectively. In this embodiment and similar to FIG. 1, once the future objected is created, data is sent to different models (i.e., the different processes that are created). See 125 of FIG. 1. In this embodiment, however, a pipe.send function called is made to send the data to the second process (i.e., the model process) where multiple models and/or pipelines may be loaded and executed.

Method 200 at 210 may receive data from the first process. Once data is received, multiple inputs corresponding to different models are received. For example, there may be several pieces of text, and each piece of text may be correlated or tied to a corresponding model (e.g., text1 corresponds to model1, text2 corresponds to model2, and so forth). At 215, data is batched and sent to a corresponding one of the pipelines at 210. In some embodiments, the batch data is sent to the pipeline it belongs to. In some embodiments, a pipeline number is sent in addition to the text. Thereafter, common pipeline numbers are batched and are sent to the corresponding pipeline.

At 220, once the pipeline is determined and selected (based on the text associated with the corresponding model), the corresponding ones of the pipelines and the thread pool are executed for the batched data. In these embodiments, each pipeline may have more than one model, and there may be more than one pipeline. For example, pipeline 1 may execute a sentence transformer model and a SKLearn classifier model, while pipelines 2 and 3 may execute sentence transformer model.

At 225, the final result of the classification from each of the one or more pipelines are sent to the second read thread and method 200 returns to the model process similar to 205. In other words, the final result (or output data) is sent sequentially into a pipe. Concurrently, and similar to FIG. 1, in order for the model process loop to continue, the semaphore is released when the data is sent into the pipe and to the second thread.

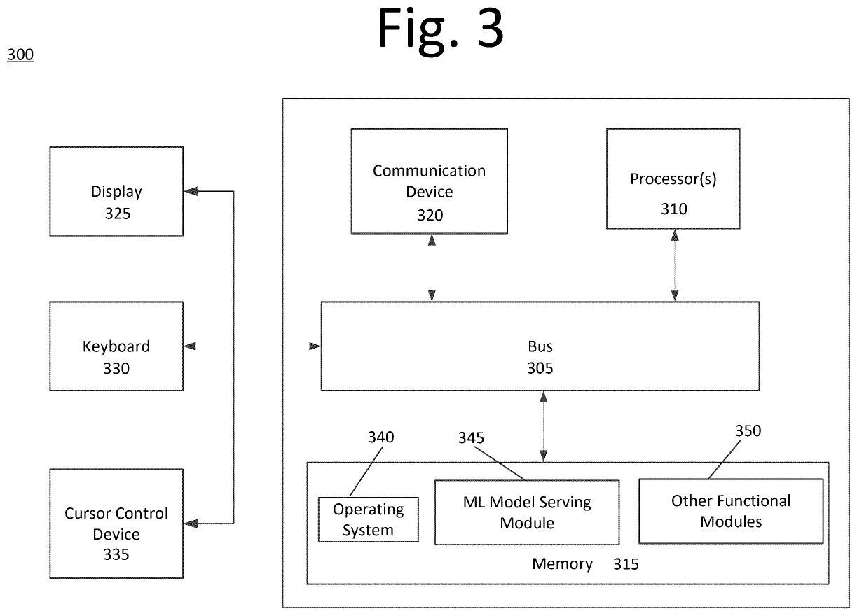

FIG. 3 is an architectural diagram illustrating a computing system 300 configured to perform ML model serving on a separate thread, according to an embodiment of the present invention. In some embodiments, computing system 300 may be one or more of the computing systems depicted and/or described herein. Computing system 300 includes a bus 305 or other communication mechanism for communicating information, and processor(s) 310 coupled to bus 305 for processing information. Processor(s) 310 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 210 may also have multiple processing cores, and at least some of the cores may be configured to perform specific functions. Multi-parallel processing may be used in some embodiments. In certain embodiments, at least one of processor(s) 310 may be a neuromorphic circuit that includes processing elements that mimic biological neurons. In some embodiments, neuromorphic circuits may not require the typical components of a Von Neumann computing architecture.

Computing system 300 further includes a memory 315 for storing information and instructions to be executed by processor(s) 310. Memory 315 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 310 and may include volatile media, non-volatile media, or both. The media may also be removable, non-removable, or both.

Additionally, computing system 300 includes a communication device 320, such as a transceiver, to provide access to a communications network via a wireless and/or wired connection. In some embodiments, communication device 320 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 320 may include one or more antennas that are singular, arrayed, phased, switched, beamforming, beamsteering, a combination thereof, and or any other antenna configuration without deviating from the scope of the invention.

Processor(s) 310 are further coupled via bus 305 to a display 325, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 325 may be configured as a touch (haptic) display, a three dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 330 and a cursor control device 335, such as a computer mouse, a touchpad, etc., are further coupled to bus 305 to enable a user to interface with computing system. However, in certain embodiments, a physical keyboard and mouse may not be present, and the user may interact with the device solely through display 325 and/or a touchpad (not shown). Any type and combination of input devices may be used as a matter of design choice. In certain embodiments, no physical input device and/or display is present. For instance, the user may interact with computing system 300 remotely via another computing system in communication therewith, or computing system 300 may operate autonomously.

Memory 315 stores software modules that provide functionality when executed by processor(s) 310. The modules include an operating system 340 for computing system 300. The modules further include a ML model serving module 345 that is configured to perform all or part of the processes described herein or derivatives thereof. Computing system 300 may include one or more additional functional modules 350 that include additional functionality.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

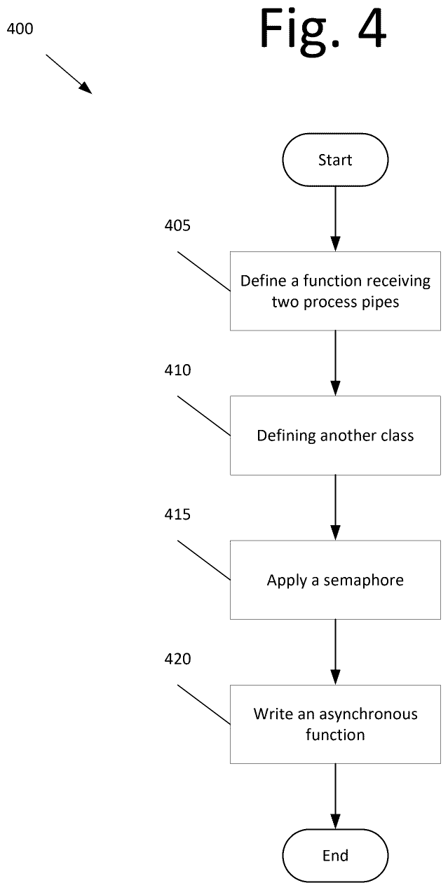

FIG. 4 is a flow diagram illustrating a method 400 for launching a defined function and communicating the defined function over pipes, according to an embodiment of the present invention. In some embodiments, method 400 may launch a separate process, which runs a defined function at application startup and communicates with the defined function over pipes in two threads to execute the ML model. Method 400 may begin at 405 with defining a function that receives two process pipes as arguments. In some embodiments, the function has two parts. The first part is any library imports and model loading will use RAM and/or VRAM. The second part is that, while a true loop is executed where the input(s) is received from the first pipe, the one or more ML models loaded in the first part are executed and an output is sent to the second pipe.

By running this indefinite running function, several advantages are realized. For example, the function is lightweight (with respect to memory consumption, computing power, importing of libraries) to create import into other modules while possibly running heavier in another process. This function also allows for the user to customize the while true loop to allow batching and other optimizations. Further, the only place where the model is loaded is another process, thereby isolating the application from model process crashing. This overhead is also close to, but less than the process pool executor.

The issue with this approach however is that the overhead requires more than threading and optimization needs to be done manually rather than automatically in the model serving framework. To overcome these issues, method 400 continues at 410 with defining another class. This class handles the creating and storing of future objects and setting the result from the other thread. At 415, a semaphore is applied to avoid overloading of the pipe, and at 420, an asynchronous function is written to the input pipe, which is one of the two pipes.

Using this method, it may be possible to quickly and reliably implement a variety of customized AI models or other CPU intensive workloads in productions without needing to test a number of complex threading or async scenarios while being compatible with async/multithreading and low latency/overhead.

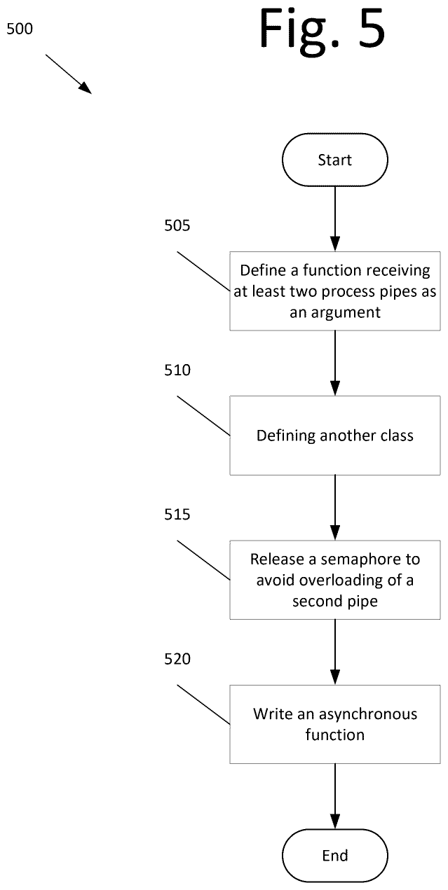

FIG. 5 is a flow diagram illustrating a computer-implemented method 400 for serving ML model over pipes, according to an embodiment of the present invention. In some embodiments, method 500 may begin at 505 with defining a function that receives at least two process pipes as arguments. At 510, method 500 includes defining another class. In these embodiments, the other class is used for creating and storing future objects and setting the result from another thread. At 515, method 500 includes releasing a semaphore to avoid overloading of the pipe once the data is sent to the other thread, and at 520, writing an asynchronous function to an input pipe in order to send the data to the other thread.

Some embodiments of the present provide one or more advantages. For example, when making changes to the model, deployments using model serving become difficult because simple blue green deployment process is not possible. Additionally, routing and sequence of deployments needs to be handled in a custom manner, which can be more complex and failure prone than standard deployments. However, with some embodiments, when the model is integrated into the microservice, deployments are simplified because standard blue green deployments can be done without need for custom routing and/or specific sequence of deployments. This simplifies the infrastructure.

By integrating the model into the microservice, testcases can be written for both the data going in and out of the pipeline, as well as the functioning of the pipeline itself. This testcase is much stronger in ensuring functionality than standard testcases that might mock the output of an API call.

Additionally, development can be simplified as secondary applications do not need to be created on the developer's machine for testing functionality, and the setup is simplified. Compatibility with a large number of frameworks relevant to AI—Numba™, OpenVINO™, PyTORCH™, TensorFlow™, SKLearn™, and SciPY™.

The process steps performed in FIGS. 1, 2, 4, and 5 may be performed by a computer program, encoding instructions for the processor(s) to perform at least part of the process(es) described in FIGS. 1, 2, 4, and 5, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 310 of computing system 300 of FIG. 3) to implement all or part of the process steps described in FIGS. 1, 2, 4, and 5, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method for serving machine learning (ML) model over at least two pipes, the method comprising:
defining a function that receives at least two process pipes as arguments;
defining another class, wherein the other class is used for creating and storing future objects and setting the result from another thread.
releasing a semaphore to avoid overloading of a second pipe once the data is sent to the other thread; and
writing an asynchronous function to a first pipe or an input pipe in order to send the data to the other thread.

2. The computer-implemented method of claim 1, further comprising:
launching a separate process, wherein the separate process comprises
running a defined function at application startup and communicating with the defined function over a plurality of pipes in two threads to execute the ML model.

3. The computer-implemented method of claim 1, wherein the function comprises a first part and a second part,
the first part comprises a library for performing importing of a model and loading of the model, and
the second part comprises
executing a true loop where one or more inputs are received from the first pipe,
executing one or more ML models loaded during the first part, and
sending an output from the execution of the one or more ML models to a second pipe.

4. The computer-implemented method of claim 1, further comprising:
sending a request function through a semaphore prior to running ML model; and
creating a future object for the semaphore to prevent overloading of the second pipe.

5. The computer-implemented method of claim 4, further comprising:
creating a data structure and adding a future from the data structure to a double ended queue, wherein
the data structure contains a list of a plurality of futures.

6. The computer-implemented method of claim 5, further comprising:
sending the future to more than one model.

7. The computer-implemented method of claim 6, further comprising:
receiving a batch size of items prior to running the more than one model;
running the more than one model in a batch; and
returning data from the batching of the more than one model back to the other thread.

8. The computer-implemented method of claim 4, further comprising:
receiving data at a second process from the first process, wherein the first process and the second process are configured to run concurrently; and
receiving a plurality of inputs corresponding to different models.

9. The computer-implemented method of claim 8, further comprising:
batching the data and sending the batch data to a corresponding one of a plurality of pipelines;

10. The computer-implemented method of claim 9, wherein the sending of the data comprising
sending pipeline number in addition to text associated with the data to the corresponding one of the plurality of the pipelines.

11. The computer-implemented method of claim 9, further comprising:
executing the corresponding ones of the plurality of pipelines and a thread pool for the batched data.

12. The computer-implemented method of claim 11, further comprising:
sending a final result from the corresponding one of the plurality of pipelines to the other thread.

13. A computer-implemented method for processing batched data using a plurality of pipelines, comprising:
receiving, from a first process, data comprising a plurality of text, each of which corresponding to one of a plurality of models;
batching, at a second process, the data;
sending, at the second process, the batched data to a corresponding one of a plurality of pipelines;
executing, at the second process, each of the corresponding ones of the plurality of pipelines for the batch data; and
returning, from the second process, to the first process a final result from the executed corresponding ones of the plurality of the pipelines.

14. The computer-implemented method of claim 13, wherein the sending of the batched data comprises
sending text associated with the batch data to the corresponding one of a plurality of pipelines.

15. The computer-implemented method of claim 13, wherein the sending of the batched data comprises
sending common pipeline numbers to the corresponding one of the plurality of pipelines.

16. The computer-implemented method of claim 13, further comprising:
identifying the corresponding one of the plurality of pipelines based on text associated with a corresponding model; and
selecting the identified corresponding one of the plurality of the pipelines.

17. The computer-implemented method of claim 13, wherein each of the corresponding one of the plurality of pipelines comprises one or more ML models.

18. The computer-implemented method of claim 17, wherein the one or more ML models comprises a sentence transformer model, a SKLearn classifier model, or both.

19. The computer-implemented method of claim 13, further comprising:
releasing a semaphore when the final result is sent to a second thread running within the first process.

20. The computer-implemented method of claim 19, further comprising:
receiving the final result from the second process at a second thread; and
sending, from the second thread, to a main thread the final result.
